(19) United States
(12) Patent Application Publication
(10) Pub. No.: US 2004/0030800 A1
(43) Pub. Date: Feb. 12, 2004

(54) Data networks

(76) Inventors: Robert H M Gray, Belfast (GB); Mark S. Boyle, Bangor (GB); Jeremy B. Chutter, Ipswich (GB); Michael A. Hale, Colchester (GB)

Correspondence Address: Nixon & Vanderhye, 1100 North Glebe Road, 8th Floor, Arlington, VA, 22201-4714, US

(21) Appl. No.: 10/221,364

(22) PCT Filed: Mar. 29, 2001
(86) PCT No.: PCT/GB01/01418

(30) Foreign Application Priority Data
Mar. 30, 2000 (EP) 00302641.6

(51) Int. Cl. G06F 15/173

(52) U.S. Cl. 709/238; 709/232

(57) ABSTRACT

There is provided a method of processing requests for target node identification data received from a first node of a data network at a second node of the data network, said first node processing user requests, said method comprising the following steps: a) storing, in a data store accessible by said second node, target node identification data for a set of a plurality of target nodes, each target node of said set being interchangeably useable by said first node to service a user request: b) receiving, at said second node, a plurality of similar requests from the first node, each one of said similar requests relating to said set of target nodes; c) in response to a first said similar request, selecting a first selection of one or more target nodes of said set and transmitting data identifying said first selection to said first node; d) in response to a second said similar request, selecting a second selection of one or more target nodes of said set and transmitting data identifying said second selection to said first node, wherein said second selection includes at least one target node which is not included in said first selection.

### FIELD OF THE INVENTION

The present invention relates to methods of, computer programs for and apparatus for processing requests for target node identification data thereby enabling a user request to be serviced. More particularly, but not exclusively, the present invention relates to methods of, computer programs for, and apparatus for processing one or more requests received by an authorisation/authentication server for data enabling a tunnel to be built to any one of a plurality of target nodes of a virtual private data network.

### BACKGROUND

In a typical arrangement for providing access to data networks, the end user of a client terminal connects to a network access server (NAS) of an access provider which, in turn, connects to a selected node of a data network, such as a content server or a home gateway (HG) of a private network. Generally, the connection between the client terminal and the NAS will use Point-to-Point Protocol (PPP). However, the connection between the NAS and the selected node, being a connection over a packet-switched data network such as the Internet, will generally use Internet Protocol (IP).

Where access is provided to a Virtual Private Data Network (VPDN) the connection between the NAS and the selected node will also use a tunnelling protocol such as Layer Two Forwarding (L2F) or Layer Two Tunnelling Protocol (L2TP). In VPDN terminology, the NAS is said to build a tunnel through the data network to the HG of the VPDN. Often, multiple HGs will be provided in a VPDN so as to provide service to larger numbers of simultaneous users. The collection of multiple HGs is known as a cluster of HGs. When providing access to multiple simultaneous end users of a VPDN using a cluster of HGs, the NAS will typically build multiple tunnels to different gateways of the cluster. This is to provide loadsharing and resilience. In general, access providers have many NASes so as to be able to provide service to large numbers of simultaneous end users.

When the client terminal first connects to a NAS, the NAS needs to perform some checks before it can provide access to the VPDN. These checks include authenticating the end user of the client terminal, checking the authorisation of the end user to use the services of the access provider, and setting up an appropriate mechanism for charging the end user for such use. These three functions are sometimes described as Authentication, Authorisation, and Accounting (AAA). One approach to implementing AAA functionality is to connect the NASes via a data link to one or more further servers which handle the authentication, authorisation and accounting functions. The industry standard protocol for providing AAA functionality for Internet access and service providers is the Remote Authentication Dial-In User Service (RADIUS) and a server conforming to the protocol is known as a RADIUS server. In general, access providers have many RADIUS servers connected to their NASes to provide loadsharing and resilience. Where an access provider has more than one RADIUS server, it is desirable for them to be functionally interchangeable so that any NAS may use any RADIUS server and the service provided will be functionally identical.

The RADIUS protocol is maintained by the Internet Engineering Task Force (IETF) and is documented in RFC 2138 (base protocol) and RFC 2139 (accounting extensions) which documents are incorporated herein by reference. Modifications to the RADIUS protocol are proposed in the IETF Internet Draft draft-ieff-radius-v2-06.txt. These three documents are available from the IETF at http://ietf.org. A method of processing access requests at an NAS/RADIUS server arrangement is described in European Patent Application No. 99309561.1, which document is incorporated herein by reference.

With an end user wishing to connect to a VPDN via an access provider, each RADIUS server will generally hold the IP addresses corresponding to HGs of the VPDN. The end user is normally given a phone number corresponding to the access provider and a user name and password or other security data. The end user dials-up the access provider using his/her client terminal, is connected to a NAS and then provides his/her user name and password. Using this information, the NAS consults a RADIUS server to authenticate/authorise the end user and set up the necessary accounting procedures. The RADIUS server also provides the NAS with the IP addresses of the HGs for building a tunnel to. Communication between the NAS and the RADIUS Server follows the client/server model with the NAS passing a request to the RADIUS server which provides a response in return.

A limitation of the RADIUS protocol is that it only permits a response string of up to a maximum of 253 characters. However, IP addresses are expressed in dotted-decimal notation, e.g. 132.252.13.255. In practice, this gives a limit of approximately 12 to 16 IP addresses that can be specified without resorting to compression techniques. Since gateways to data networks, including HGs of a VPDN, can only handle a limited number of simultaneous users (presently a maximum of approximately 1,000 to 1,500 simultaneous users) this limitation of the RADIUS protocol results in a limit of the number of simultaneous users that can be provided with access to a data network, such as a VPDN, via one access provider.

Moreover, the operating systems used by currently commercially available NASes, such as those available from Cisco Systems, Inc. (TM) and Lucent Technologies, Inc. (TM), result in a more stringent limitation in that the NAS can only accept a response string of up to 80 characters from the RADIUS server for specifying the HGs of a VPDN. In practice, this means that the RADIUS server can only provide about 4 IP addresses corresponding to HGs of a VPDN. This limits the number of simultaneous users of the VPDN to a maximum of approximately 6,000.

The limitations identified above present significant problems in providing access or service to data networks, such as VPDNs, requiring larger numbers of simultaneous users. The present invention provides a solution to these problems.

### SUMMARY OF THE INVENTION

According to a first aspect of the present invention there is provided a method of processing requests for target node identification data received from a first node of a data network at a second node of the data network, said first node processing user requests, the second node having access to a data store in which is stored target node identification data for a set of a plurality of target nodes, each target node of said set being interchangeably useable by said first node to service a user request, said method comprising the following steps: a) receiving, at said second node, a plurality of similar requests from the first node, each one of said similar requests relating to said set of target nodes; b) in response to a first said similar request, selecting a first selection of one or more target nodes of said set and transmitting data identifying said first selection to said first node; c) in response to a second said similar request, selecting a second selection of one or more target nodes of said set and transmitting data identifying said second selection to said first node, wherein said second selection includes at least one target node which is not included in said first selection.

According to a second aspect of the present invention there is provided a method of responding to requests received from a first node by a second node, said method being to provide, from said second node to said first node, a plurality of different responses to a plurality of requests, each one of said requests comprising data from which a plurality of nodes of a data network can be identified, each one of said responses providing information enabling the first node to build a tunnel to one or more nodes selected from said plurality of nodes but not to all said nodes, wherein the plurality of responses enable the first server to build a tunnel to any one said plurality of nodes of the data network.

According to a third aspect of the present invention there is provided a method of providing a first node with information from a second node, said information enabling the first node to build a tunnel to more nodes of a data network than the first node is able to receive in a single request-response transaction; said method being to provide said information in a plurality of responses to a plurality of requests, each one of said requests comprising data from which said information can be identified.

According to a fourth aspect of the present invention there is provided a method of providing a first node with information from a second node, said information enabling the first node to build a tunnel to more nodes of a data network than the first node is able to receive in a single request-response transaction; said method being to provide said information in a plurality of responses to a plurality of requests, each one of said requests comprising data from which said information can be identified.

According to a fifth aspect of the present invention there is provided a method of processing requests for data enabling a plurality of nodes of a data network to be accessed, said method comprising the following steps: a) receiving at a first node a first and a second request, both said requests comprising data indicating a plurality of target nodes; b) for both said requests, selecting a different one or more target nodes from said indicated plurality of target nodes; c) responding to said requests by sending data enabling said respective different one or more target nodes to be accessed.

An advantage of the present invention is that it enables access providers to provide access or service to data networks, such as VPDNs, comprising a greater number of HGs than conventionally possible, and thereby to provide access to larger numbers of simultaneous end users than conventionally possible.

There now follows, by way of example only, a detailed description of preferred embodiments of the present invention in which:

### BRIEF DESCRIPTION OF THE DRAWINGS

FIG. 1 shows a simple arrangement of data processing elements for providing an end user with access to a VPDN;

FIG. 2 shows a more general arrangement of data processing elements for providing an end user with access to a VPDN;

FIG. 3 is a time line diagram showing a typical sequence of interactions between data processing elements involved in establishing a data link for providing an end user with access to a VPDN;

FIG. 4 shows a list structure and a set of successive responses to similar requests according to first, second and third embodiments of the present invention; and

FIG. 5 shows a list structure and set of successive responses to similar requests according to fourth, fifth and sixth embodiments of the present invention.

### DETAILED DESCRIPTION OF EMBODIMENTS OF THE PRESENT INVENTION

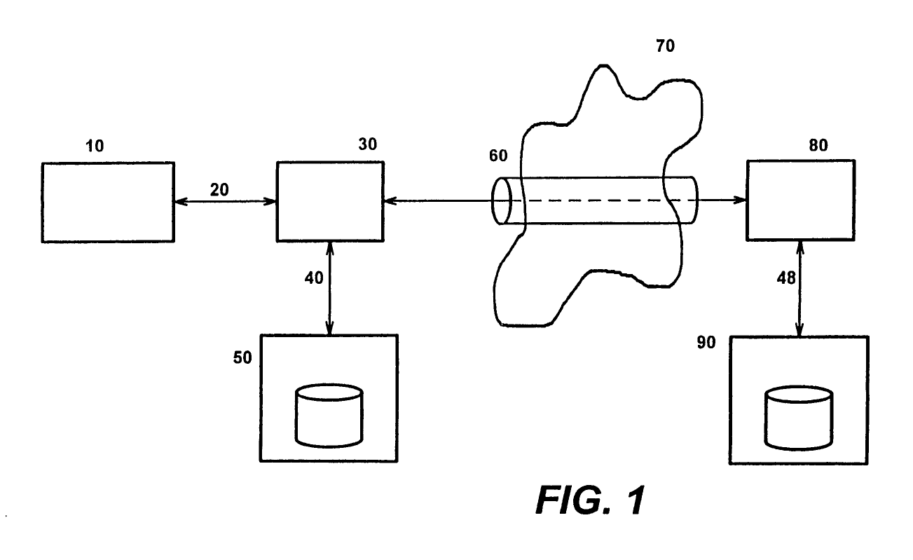

FIG. 1 shows a simple arrangement of data processing elements for providing an end user with access to a VPDN. Client terminal 10 is connected to NAS 30 over a PPP link 20. Typically, the physical link is provided by the Public Switch Telephone Network (PSTN) with a pair of modems (not shown) at each end of the connection. Alternatively, the physical link may be provided over an Integrated Services Digital Network (ISDN) link or a Digital Subscriber Link (DSL) such as Asynchronous DSL (ADSL).

NAS 30 is connected to RADIUS server 50 over a data link 40. Typically, the NAS 30 and RADIUS server 50 will communicate using the User Datagram Protocol over the Internet Protocol (UDP/IP). This provides a fast service for transmitting high volume traffic between NAS 30 and RADIUS server 50. RADIUS server 50 also comprises one or more databases for storing the IP addresses of HGs of the VPDN and for maintaining data concerning the end user's use of the service for accounting and other purposes.

When providing access to a VPDN, NAS 30 builds a tunnel 60 using a tunnelling protocol such as L2F or L2TP through the Internet 70 to a HG 80 of the VPDN. Using tunnel 60, NAS 30 is able to provide the end user of client terminal 10 with access to the VPDN. Where the VPDN is arranged to provide its own AAA functionality HG 80 is connected to RADIUS server 90 over a data link 48 in the same manner as described above.

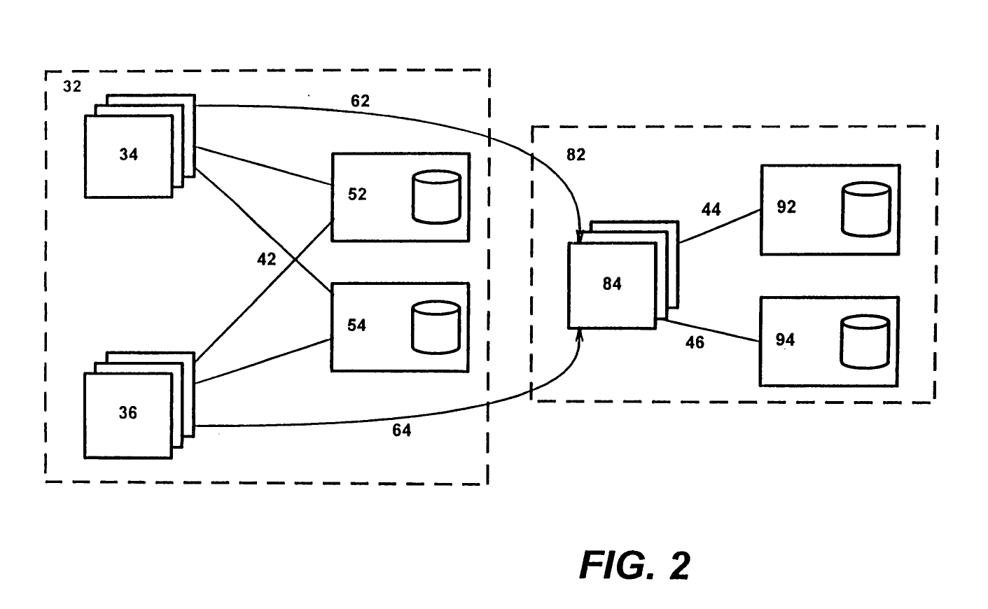

FIG. 2 shows a more general arrangement of data processing elements, for providing an end user with access to a VPDN, such as may be used by a typical access provider. The arrangement comprises an access provider domain 32 and a VPDN domain 82. Access provider domain 32 comprises two clusters of NASes 34 and 36 located at two Points of Presence (PoPs). Access providers typically locate PoPs in different geographic locations to provide service to local end users. In access provider domain 32, NAS clusters 34 and 36 are each linked to two RADIUS servers 52 and 54 via data links 42 using UDP as described above. RADIUS servers 52 and 54 may or may not be located at the two PoPs. However, generally each NAS of NAS clusters 34 and 36 will be connected to each RADIUS server for loadsharing and resilience. Each NAS will select one of the RADIUS servers according to a predetermined selection algorithm when requesting AAA services.

VPDN domain 82 comprises a plurality of HGs arranged in a HG cluster 84 connected to two RADIUS servers 92 and 94 via data links 44 and 46. The RADIUS servers 92 and 94 provide AAA functionality to the VPDN in the same way that the RADIUS servers 52 and 54 provide AAA functionality to the access provider. Any of the NASes of NAS clusters 34 and 36 may build tunnels such as 62 and 64 to any of the HGs of HG cluster 84.

An end user of a client terminal (not shown in this Figure) may connect to any NAS of NAS clusters 34 and 36. Typically, the access provider will assign a local telephone number to each NAS cluster in a PoP. An end user will dial one of these numbers using his/her client terminal and will be connected to one of the NASes selected from the corresponding NAS cluster. The selected NAS will authenticate and check the authorisation of the end user by consulting one of the RADIUS servers 52 and 54. If the end user is successful, the NAS will provide access to the VPDN by building a tunnel to one of the HGs selected from HG cluster 84. The HG will be selected by the NAS from a list provided by the authorising RADIUS server. This list will contain the IP addresses of corresponding HGs selected from HG cluster 84. The IP addresses of the HGs of the VPDN corresponding to the particular end user have been pre-programmed into the databases of RADIUS servers 52 and 54.

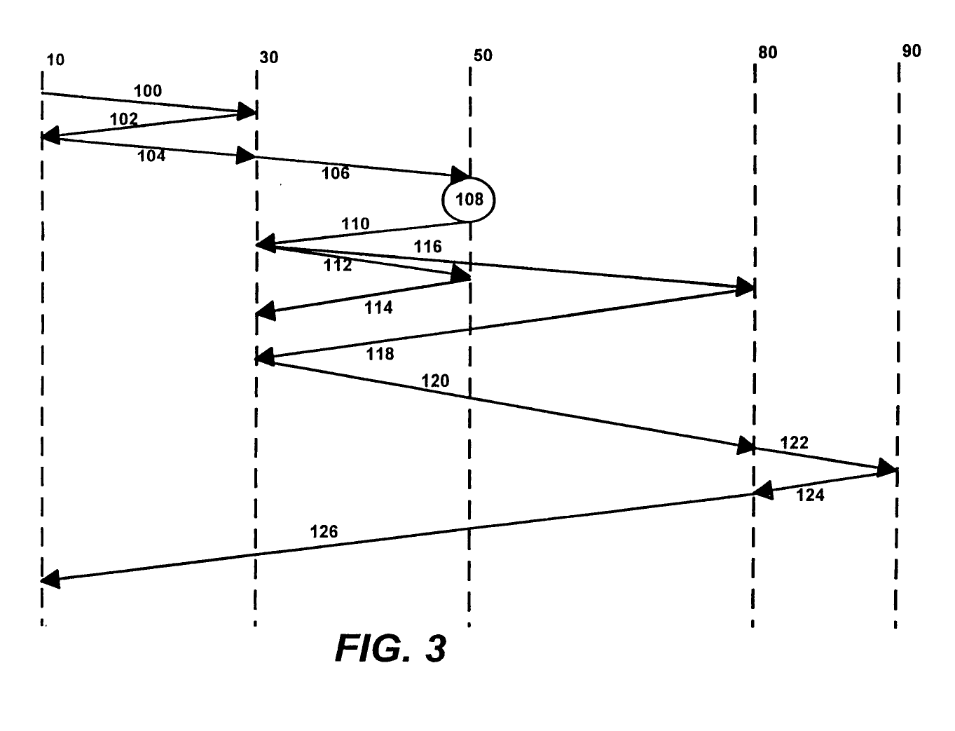

FIG. 3 shows a typical sequence of interactions between the various data processing elements involved in providing an end user with access to a VPDN. The simple arrangement of data processing elements described above with reference to FIG. 1 will be assumed although the sequence of interactions clearly applies to other arrangements of data processing elements such as the more general arrangement described above with reference to FIG. 2. The vertical lines in FIG. 3 represent the various data processing elements involved: client terminal 10, NAS 30, RADIUS server 50 connected to the NAS, HG 80, and RADIUS server 90 connected to the HG. The transverse arrows represent request-response transactions taking place between the various data processing elements.

At step 100, client terminal 10 requests the establishment of a PPP connection by passing a message to NAS 30. At step 102 NAS 30 responds by sending client terminal 10 a challenge using the Challenge Handshake Authentication Protocol (CHAP). The end user then enters information such as his user name, comprising a user name part and a domain name part, and a password at client terminal 10 and these are forwarded to NAS 30 in the form of a CHAP response at step 104. At step 106, NAS 30 passes an access request message to RADIUS server 50. The access request message contains information identifying the end user of client terminal 10 such as the complete user name, joint the domain name part of the user, or, alternatively, the telephone number from which the client terminal dialled in using the Dialled Number Information Service (DNIS).

At step 108, in response to the access request message, RADIUS server 50 performs a database query using the end user identification information provided to authenticate the end user, check the end user's authorisation, if authorised, and provide IP addresses corresponding to HGs of the VPDN. The IP addresses of the HGs of the VPDN corresponding to the particular end user have been pre-programmed into the database of RADIUS server 50. If the end user is successful, RADIUS server 50 sends an access accept message to access server 30 at step 110. This message contains selected IP addresses of HGs of the VPDN for building a tunnel to. If the end user is unsuccessful, RADIUS server 50 sends an access reject message to access server 30. Access server 30 may then send a further access request message to RADIUS server 50 using different end user identification information, and the process may be repeated until access is either accepted or finally rejected.

With implementations using NASes provided by Cisco Systems, Inc. (TM), the authentication sequence follows a three-phase model. Up to three access request messages are sent from the NAS to the RADIUS server in sequence to authenticate/authorise the end user. The first attempt uses DNIS—i.e. the dialled-in telephone number—to identify the user; if this fails the second attempt uses the domain part of the user name; if this fails the third and final attempt uses the complete user name. If the third attempt fails then access is denied.

Assuming the end user is successful as mentioned above, the access accept message contains the IP addresses of HGs of the VPDN for building a tunnel to. Because of the above-mentioned limitations on the length of the access accept message transmissible by the RADIUS server and on the length of messages acceptable to certain commercially available NASes, it may be that only the IP addresses of a selected subset of the HGs of the VPDN are provided in the access accept message. However, IP addresses corresponding to different ones of the entire set of HGs are provided in response to successive access requests as described below in greater detail.

Having received the access accept message, NAS 30 sends an accounting request message to RADIUS server 50 at step 112 which replies at step 114 with an accounting response message in confirmation. Simultaneously, at step 116, NAS 30 builds a tunnel using a tunnelling protocol such as L2F or L2TP to HG 80 of the VPDN selected from the HG IP addresses provided in the access accept message at step 110. NAS 30 uses an algorithm to select which one of the HGs to build a tunnel to. At step 118 HG 80, i.e. the selected HG, responds to NAS 30 confirming the establishment of the tunnel.

At step 120, NAS 30 replays the request for establishment of a PPP connection originally sent by client terminal 10 at step 100. However, at step 120, the request is passed from NAS 30 to HG 80 of the VPDN through the tunnel. At step 122 HG 80 passes an access request message to RADIUS server 90 of the VPDN, which queries its database. If the end user is successful, RADIUS server 90 passes an access accept message to HG 80 at step 124 and HG 80 completes the establishment of the PPP connection to client terminal 10 by passing information including an IP address assigned to client terminal 10 through the tunnel and through to client terminal 10 at step 126. This completes the establishment of the data link for providing the end user with access to the VPDN.

First, Second and Third Embodiments of the Present Invention

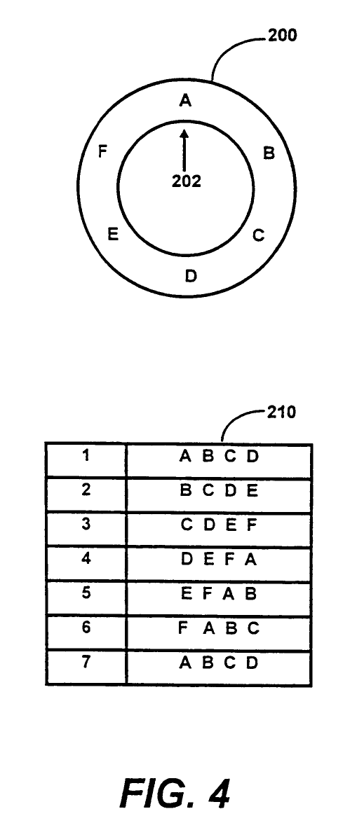

Methods of selecting a subset of the entire set of HGs of a VPDN will now be described with reference to FIG. 4. The simple arrangement of data processing elements described above with reference to FIG. 1 will be assumed although other arrangements of data processing elements, such as the more general arrangements described above with reference to FIG. 2, will clearly be possible. Let us also assume, for the purposes of illustration, that the HG cluster of the VPDN comprises six HGs represented by the letters A, B, C, D, E and F, and that RADIUS server 50 can provide NAS 30 with IP addresses corresponding to only four of the HGs of the VPDN in a single access accept message.

FIG. 4 shows a list structure and a set of successive responses to similar requests according to first, second, and third embodiments of the present invention. RADIUS server 50 maintains a circular list 200 for each end user, or group of end users, for whom access to the VPDN is to be provided. Circular list 200 comprises the IP addresses of each of the HGs of the VPDN as its elements. Circular list 200 has no repetitions. RADIUS server 50 also maintains a pointer 202 for each such end user or group of end users.

According to the first embodiment of the present invention, on initialisation or resetting of RADIUS server 50, pointer 202 is set to point to a first element of list 200 such as HG A. For each successful access request message received, RADIUS server 50 selects four successive IP addresses from circular list 200 starting with the element indicated by pointer 202. These four IP addresses are sent to NAS 30 in the responding access accept message. Pointer 202 is then set to the next successive element on circular list 200.

Table 230 shows the IP addresses provided in seven successive access accept messages. With pointer 202 initially set to HG A, the first access accept message provides IP addresses for HGs A, B, C and D as shown in row 1 of table 230. The second access accept message provides IP addresses for HGs B, C, D and E, and so on until the cycle repeats itself on the seventh access accept message. Thus, over a set of six successive access accept/access accept transactions RADIUS server 50 is able to provide to NAS 30 IP addresses corresponding to all six HGs of the VPDN. Moreover, the weighting between the six HGs is equal with each place in the list of IP addresses provided in each single access accept message being occupied by the IP address of each of the HGs exactly once.

If RADIUS server 50 is functioning properly, this method provides equal loadsharing of HGs A to F over time whilst still providing resilience in case one of the HGs is non-functional in that each access accept message provides four different HGs to which NAS 30 may build a tunnel. However, in a situation in which problems are occurring with RADIUS server 50, such as unforeseen errors occurring which require the RADIUS server to be periodically reset, it may be advantageous to provide NAS 30 with IP addresses corresponding to a randomly selected subset of the entire set of HGs of the VPDN.

According to a second embodiment of the present invention, which is a variant of the first embodiment, pointer 202 is set to point to one of the elements of circular list 200 at random each time an access accept message has been transacted. Thus, for each access accept message, IP addresses corresponding to four successive HGs from circular list 200 are provided, but the first element is selected at random. Thus, over a sufficiently long series of access requests/access accept transactions, RADIUS server 50 is able to provide NAS 30 with the IP addresses of all six HGs of the VPDN, evenly distributed as described above, despite the possibility that RADIUS server 50 may need to be occasionally reset.

According to a third embodiment of the present invention, which is a variant of the second embodiment, pointer 202 is randomised as before but only immediately after initialisation or resetting of RADIUS server 50. After initially being randomised, pointer 202 progresses sequentially through circular list 200 as described above with respect to the first embodiment. This method provides a compromise between the objectives of the first and second embodiments in that loadsharing problems caused by the need to reset RADIUS server 50 are addressed by initially randomising pointer 202, but evenly distributed loadsharing is achieved at a finer scale after initialisation or resetting by progressing pointer 202 sequentially through such a list 200.

Fourth, Fifth and Sixth Embodiments

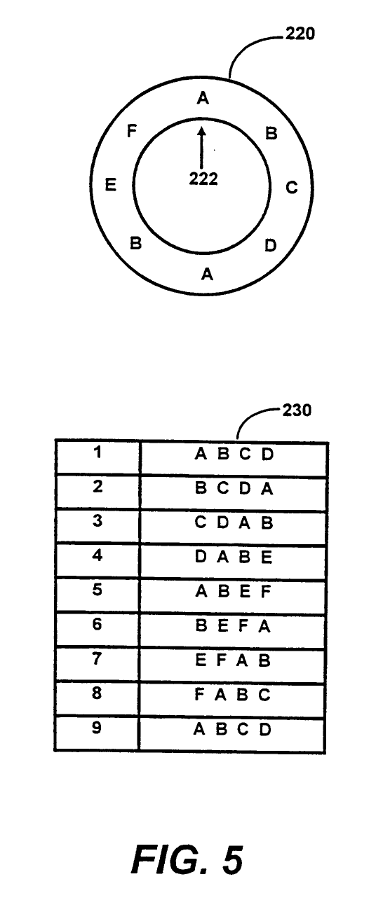

Methods of selecting a subset of the entire set of HGs of a VPDN will now be described with reference to FIG. 5. Again, the simple arrangement of data processing elements described above with reference to FIG. 1 will be assumed although other arrangements of data processing elements such as the more general arrangements described above with reference to FIG. 2 will clearly be possible. Let us again assume, for the purposes of illustration, that the HG cluster of the VPDN comprises six HGs represented by the letters A, B, C, D, E and F, and that RADIUS server 50 can only provide NAS 30 with IP addresses corresponding to only four of the HGs of the VPDN in a single access accept message.

FIG. 5 shows a list structure and a set of successive responses to similar requests according to fourth, fifth, and sixth embodiments of the present invention which are respectively variants of the first, second and third embodiments described above. As before, RADIUS server 50 maintains a circular list 220 for each end user, or group of end users, for whom access to the VPDN is to be provided. As before, circular list 220 comprises the IP addresses of each of the HGs of the VPDN as its elements. However, unlike circular list 200, circular list 220 does have repetitions—for example, HGs A and B both appear twice. RADIUS server 50 also maintains a pointer 222 for each end user or group of end users. The functioning of pointer 222 for the fourth, fifth, and sixth embodiments is as with pointer 202 described above according to the first, second and third embodiments respectively. However, the presence of repetitions in circular list 220 creates a weighting of the IP addresses of HGs provided in a series of access accept messages. This is useful if some HGs of a VPDN are to be preferred over others, for example, if some HGs are able to handle greater numbers of simultaneous end users that others. Furthermore, circular list 220 has been chosen so that, despite repetitions, any selection of four successive elements of the list will contain four different HGs. Thus, when RADIUS server 50 sends the IP addresses of four successive elements of the circular list to NAS 30, there will be four different IP addresses corresponding to four different HGs for NAS 30 to choose from with no wasteful repetitions.

Table 230 shows the IP addresses provided in seven successive access accept messages according to the fourth embodiment of the present invention. With pointer 222 initially set to HG A, the first access accept message provides IP addresses for HGs A, B, C and D as shown in row 1 of table 230. The second access accept message provides IP addresses for HGs B, C, D and A, and so on until the cycle repeats itself on the ninth access accept message. Thus, over a set of eight successive access accept/access accept transactions RADIUS server 50 is able to provide to NAS 30 IP addresses corresponding to all six HGs of the VPDN. However, the weighting between the six HGs is not even with HGs A and B featuring twice as often as HGs C, D, E and F.

Since pointer 222 performs the same function in each of the fourth, fifth and sixth embodiments as pointer 202 does, in the first, second and third embodiments, the fourth embodiment is susceptible to failure of RADIUS server 50 as described above. The fifth and sixth embodiments, however, address the possibility of RADIUS server failure as do the second and third embodiments respectively, save that, over a sufficiently long series of access requests/access accept transactions, the weighting between HGs is not even with HGs A and B featuring twice as often as HGs C, D, E and F.

It is to be understood that variations of the above-described embodiments of the present invention are possible in which the circular list structure comprises some or all of the HGs of the VPDN, with one or more repetitions of some or all of the elements, arranged in any order whatsoever. It is also to be understood that one or more elements of the circular list may be passed in each access accept message, and that, where more than one element is passed, the elements may be chosen in succession from the pointer or according to an alternate rule.

It is also to be understood that data structures other than circular lists may be used to implement the present invention, such as linear lists, hierarchical structures and networked structures.

It is also to be understood that variations of the above-described embodiments are possible in which the HG is not directly connected to a VPDN but to a NAS of a further service provider. The function of the further NAS may be to connect users to a VPDN, or to the Internet.

It is also to be understood that a NAS and RADIUS server of the present invention may be implemented in the same data processing device and that a RADIUS server or servers may be substituted by a server or servers performing equivalent functions such as servers conforming to the IETF's DIAMETER protocol or Common Open Policy Service protocol (COPS). The DIAMETER framework and architecture is defined in draft-calhoun-diameter-framework-05.txt and the base protocol in draft-calhoun-diameter-12.txt. The COPS framework and architecture is defined in draft-ietf-rap-framework-03.txt and the base protocol in draft-ietf-rap-cops-08.txt. All four documents are available from the IETF at http://ieff.org. Similarly, a NAS may be substituted by a server or servers performing similar functions such as a proxy server, a firewall or a redirect server.

The methods according to the invention will typically be performed by suitably programmed equipment. The equipment would typically be programmed by loading to memory of the equipment the relevant programme or programmes. The programme(s) would typically be delivered on a suitable data carrier, such as an optically readable memory (e.g. CDROM, DVD, mini-disc, etc.), or a magnetically readable memory (e.g. tape, disc, hard drive etc.) or on an optical or radio frequency carrier (over an optical fibre link or a radio link) or as an electrical signal via a wired data link. Where permitted, protection is sought for the programme(s) and/or the programme(s) on a suitable (e.g. computer-readable) data carrier.

1. A method of processing requests for target node identification data received from a first node of a data network at a second node of the data network, said first node processing user requests, the second node having access to a data store in which is stored target node identification data for a set of a plurality of target nodes, each target node of said set being interchangeably useable by said first node to service a user request, said method comprising the following steps:
a) receiving, at said second node, a plurality of similar requests from the first node, each one of said similar requests relating to said set of target nodes;
b) in response to a first said similar request, selecting a first selection of a plurality of target nodes of said set and transmitting data identifying said first selection to said first node;
c) in response to a second said similar request, selecting a second selection of a plurality of target nodes of said set and transmitting data identifying said second selection to said first node,
wherein said second selection includes at least one target node which is not included in said first selection.

2. A method according to claim 1, wherein the plurality of target nodes are selected so that the data transmitted to the first node in response to the plurality of similar requests tends to distribute the occurrence of each of the target nodes of the set according to a predetermined weighting.

3. A method according to claim 2, wherein the target nodes are selected so that the data transmitted to the first node in response to the plurality of similar requests tends to distribute the occurrence of each of the target nodes of the set substantially evenly among the plurality of target nodes.

4. A method according to claim 2, wherein the target nodes are selected so that the data transmitted to the first node in response to the plurality of similar requests tends to distribute the occurrence of each of the target nodes of the set so as to favour the occurrence of one or more of said target nodes in said distribution over other of said target nodes.

5. A method according to any preceding claim, wherein the plurality of similar requests are received at the second node in succession and for each said request the first of the plurality of selected target nodes are selected according to a predetermined sequence.

6. A method according to any of claims 1 to 4, wherein the plurality of similar requests are received at the second node in succession and for each said request the first of the plurality of selected target nodes are selected according to a random sequence.

7. A method according to claim 5, wherein the predetermined sequence comprises repeated elements.

8. A method according to claim 5, wherein the predetermined sequence does not comprise repeated elements.

9. A method according to any of claims 5 to 8, wherein, when two or more target nodes are selected in response to one request, each of said two or more target nodes are different.

10. A method according to any preceding claim, wherein the first node comprises a network access server.

11. A method according to any preceding claim, wherein the second node comprises an authentication or authorisation server.

12. A method according to any preceding claim, wherein the target node identification data for a particular target node comprises a network address of said target node.

13. A method according to any preceding claim, wherein the set of a plurality of target nodes is a home gateway or home gateway cluster of a virtual private data network.

14. A method according to any claim 13, wherein the target node identification data enables the first node to establish a data packet tunnel to a home gateway of the virtual private data network.

15. A method of responding to requests received from a first node by a second node, said method being to provide, from said second node to said first node, a plurality of different responses to a plurality of requests, each one of said requests comprising data from which a plurality of nodes of a data network can be identified, each one of said responses providing information enabling the first node to build a tunnel to a plurality of nodes selected from said plurality of nodes but not to all said nodes, wherein the plurality of responses enable the first server to establish a data packet tunnel to any one said plurality of nodes of the data network.

16. A method of providing a first node with information from a second node, said information enabling said first node to establish a data packet tunnel to more nodes of a data network than the second node is able to identify in a single request-response transaction; said method being to provide said information in a plurality of responses to a plurality of requests, each one of said requests comprising data from which said information can be identified.

17. A method of providing a first node with information from a second node, said information enabling the first node to establish a data packet tunnel to more nodes of a data network than the first node is able to receive in a single request-response transaction; said method being to provide said information in a plurality of responses to a plurality of requests, each one of said requests comprising data from which said information can be identified.

18. A method of processing requests for data enabling a plurality of nodes of a data network to be accessed, said method comprising the following steps:
a) receiving at a first node a first and a second request, both said requests comprising data indicating a plurality of target nodes;
b) for both said requests, selecting a different plurality of target nodes from said indicated plurality of target nodes;
c) responding to said requests by sending data enabling said respective different plurality of target nodes to be accessed.

19. A computer program for performing the method of any preceding claim.

20. A computer program for performing the method of any of claims 1 to 18 on a data carrier.

21. One or more data processing devices arranged to perform the method of any one of claims 1 to 18.
